(19) United States
(12) Patent Application Publication
(10) Pub. No.: US 2011/0220154 A1
(43) Pub. Date: Sep. 15, 2011

(54) Dental Appliance Cleanser

(76) Inventor: Sean M. Wetterer, Murray, NJ (US)

(21) Appl. No.: 13/129,405

(22) PCT Filed: Nov. 17, 2009
(86) PCT No.: PCT/US09/64661

§ 371 Date: May 16, 2011

Related U.S. Application Data
(60) Provisional application No. 61/115,164, filed on Nov. 17, 2008.

(51) Int. Cl. B08B 3/04; A61Q 11/02; C11D 3/26

(52) U.S. Cl. 134/26; 510/116

(57) ABSTRACT

This disclosure relates to a persulfate-free dental appliance cleanser containing a low-concentration of chlorhexidine, or a pharmaceutically acceptable salt thereof.

### BACKGROUND OF THE INVENTION

1. Field of the Invention

This disclosure relates to a persulfate-free dental appliance cleanser containing a low-concentration of chlorhexidine, or a pharmaceutically acceptable salt thereof.

2. Description of the Related Art

Full or partial dentures are intended to be worn in the mouth to replace missing teeth. Like teeth, dentures and other dental appliances should be cleaned regularly to maintain good oral health. Like teeth, dental appliances should also be cleaned regularly for cosmetic reasons, for example to maintain fresh breath. It is well known that microbiological deposition and proliferation on dentures and other dental appliances causes a number of problems for patients and their treating dentists. Such problems include odor, denture-induced stomatitis, staining and an unpleasant taste to the appliance as well as within the oral cavity.

Unlike teeth, dentures and other dental appliances can be removed for cleaning. Dental appliances are also made of durable materials, such as acrylic polymers, that can withstand relatively harsh cleaning conditions. As a result, they can be, and sometimes are, exposed to harsh cleaning conditions. They are typically cleaned in one of two ways, either they are soaked for some time in a cleansing bath or they are brushed with dentifrices or specially formulated cleansing creams.

Brushing with dentifrices or creams has the advantage of supplementing the cleaning formulation with mechanical action. Unfortunately, as with teeth, spots on the dental appliances can be missed or overlooked during the brushing process. As a result, the remaining teeth and gums of the user may be exposed to disease agents and undesirable cosmetic consequences. In addition, brushing with a toothpaste containing abrasive components may cause the material of the dental appliance to become scratched or worn down.

Soaking in a cleansing bath offers the advantage of reaching every part of a denture for cleaning. Full immersion of the denture in the bath allows the cleansing composition to reach occluded or internal surface areas that can not be reached by ordinary brushing with dentifrices or creams. Typically, the active ingredients are sold in solid form, as a denture cleanser powder or tablet, or in concentrated liquid form. The active ingredients are then dissolved in a water bath to form the cleansing bath.

While badly stained dentures or those with significant bacterial contamination may require long-term (e.g., overnight) soaking, patients often object to being without their prostheses for extended periods. In addition, simple soaking surrenders the advantage of mechanical scrubbing found with creams and dentifrices. To compensate for this loss of mechanical cleaning, denture cleansing tablets and powders may contain an effervescent system to mimic mechanical scrubbing in conjunction with chemical cleaning agents. Alternatively, the cleansing bath can be applied to the dental appliance within a container that has motors, vibrators, ultrasound generators, or other means of agitating the cleansing bath.

The effectiveness of chlorhexidine (1,6-di-4′-chlorophenyldiguanidohexane), or salts thereof, in preventing the occurrence of, or in removing human dental plaque, is well known. It is also well known that even the short use of chlorhexidine, or a salt thereof, in dental and oral care compositions causes brown staining of the teeth and tongue. U.S. Pat. No. 3,957,967, issued May 18, 1976, teaches using an amount of urea sufficient to reduce the staining effect of chlorhexidine in dental formulations useful in cleaning natural teeth and dentures. U.S. Pat. No. 3,960,745, issued Jun. 1, 1976, teaches a skin cleansing composition containing a soluble salt of chlorhexidine in combination with a surfactant which is a polyoxyethylene-polyoxypropylene block copolymer rather than standard surfactants, such as anionic surfactants, which are taught to be incompatible with chlorhexidine. WO 91/15189, published Oct. 17, 1991, discloses a toothpaste with a combination of 0.02%-2.0% chlorhexidine digluconate and 0.05%-2.0% sodium monofluorophosphate, to reduce the bacteria associated with stomatitis and mucositis, wherein the monofluorophosphate salt reduces the staining effect of the chlorhexidine.

The inventors herein have discovered that low concentrations of chlorhexidine, or a salt thereof, can be used to fight plaque in a persulfate-free dental appliance cleanser composition, wherein the cleanser composition contains a surfactant selected from a cationic surfactant, a non-ionic surfactant, a zwitterionic surfactant, or a combination thereof, and wherein there is no staining associated with the chlorhexidine, or salt thereof.

### SUMMARY OF THE INVENTION

In one aspect, this disclosure relates to a persulfate-free dental appliance cleansing formulation comprising a low concentration of chlorhexidine, or a pharmaceutically acceptable salt thereof.

In another aspect, this disclosure relates to a persulfate-free dental appliance cleansing formulation comprising a low concentration of chlorhexidine, or a pharmaceutically acceptable salt thereof, and a surfactant selected from a cationic surfactant, a non-ionic surfactant, a zwitterionic surfactant, or a combination thereof.

In a further aspect, this disclosure relates to a persulfate-free dental appliance cleansing formulation comprising a low concentration of chlorhexidine, or a pharmaceutically acceptable salt thereof, an oxidizing agent selected from a perborate salt and a percarbonate salt, and a surfactant selected from a cationic surfactant, a non-ionic surfactant, a zwitterionic surfactant, or a combination thereof.

In a yet a further aspect, this disclosure relates to a method of cleansing a dental appliance outside the oral cavity comprising maintaining the dental appliance in contact with a persulfate-free dental appliance cleansing formulation comprising a low concentration of chlorhexidine, or a pharmaceutically acceptable salt thereof, for a time sufficient to clean the dental appliance and rinsing the dental appliance with water.

In another aspect, this disclosure relates to a method of cleansing a dental appliance outside the oral cavity comprising maintaining the dental appliance in contact with a persulfate-free dental appliance cleansing formulation comprising an effervescent system and a low concentration of chlorhexidine, or a pharmaceutically acceptable salt thereof, for a time sufficient to clean the dental appliance and rinsing the dental appliance with water.

In still another aspect, this disclosure relates to a method of cleansing a dental appliance outside the oral cavity comprising maintaining the dental appliance in contact with a persulfate-free dental appliance cleansing formulation comprising an effervescent system, a surfactant and a low concentration of chlorhexidine, or a pharmaceutically acceptable salt thereof, for a time sufficient to clean the dental appliance and rinsing the dental appliance with water.

In yet another aspect, this disclosure relates to a method for preventing the occurrence and/or reducing the incidence of dental plaque in the mouth of a dental appliance wearer by cleansing the dental appliance with a persulfate-free dental appliance cleansing formulation comprising an effervescent system, a surfactant and a low concentration of chlorhexidine, or a pharmaceutically acceptable salt thereof, for a time sufficient to clean the dental appliance and rinsing the dental appliance with water, and placing the dental appliance in the mouth of the wearer.

### DETAILED DESCRIPTION OF THE INVENTION

The terms “clean”, “cleansing” or “cleaning” are used interchangeably herein to refer to removing food particles, stain and other oral debris, both on the surface and within the pores of a dental appliance, with the formulation disclosed herein.

The terms “chlorhexidine” and “CHX” are used interchangeably.

The term “dental appliance” is used herein to refer to dentures or partial dentures, artificial teeth, removable orthodontic bridges and denture plates, both upper and lower types, orthodontic retainers and appliances, protective mouthguards, nightguards to prevent bruxism and/or Temporomandibular joint (TMJ) disorder, and the like.

The term “denture cleanser” is used herein to refer to a formulation for use outside the mouth to clean dental appliances.

The instant inventive dental appliance cleanser formulation can be made into a powder or tablet, and is particularly useful for application as a tablet cleanser. Furthermore, in one specific embodiment, the tablet is placed in a water bath which is preferably preheated to an elevated temperature between 30 and 50° C. In another embodiment, the tablet is placed in a water bath which is heated to a temperature between 50 and 70° C.

Suitably, the dental appliance cleanser formulation contains chlorhexidine, or a pharmaceutically acceptable salt thereof, in an amount between 0.01 to 5.00 percent by weight (“wt. %”) of the total formulation. The choice of concentration in the formulation will be strongly influenced by the recommended dilution of the product during usage by the consumer. In one embodiment, chlorhexidine, or a pharmaceutically acceptable salt thereof, is present in an amount of 0.05 wt. %. The resulting formulation may be applied to water at a concentration of 2.75 g cleanser in 150 mL water. It will be understood that a 0.1 wt. % tablet concentration of chlorhexidine is equivalent to 2.75 mg in 150 mL of the cleaning solution or 0.0018% (w/v) of chlorhexidine. The 0.2% tablet concentration of chlorhexidine is equivalent to 2.75 mg in 150 mL of the cleaning solution or 0.0037% (w/v).

Suitable salts of chlorhexidine which are soluble in water at ambient temperature to the extent of at least 0.5% w/v are, for example, gluconate, isethionate (2-hydroxyethanesulphonate), formate, acetate, glutamate, succinamate, monodiglycollate, di-methanesulphonate, lactate, di-isobutyrate and glucoheptonate.

The dental appliance cleanser formulation suitably utilizes at least one oxidizing agent. The oxidizing agent provides the source for active oxygen needed during the cleaning process. Unlike standard denture appliance cleansers, the instant formulations do not contain persulfate oxidizing agents which were found to be incompatible with chlorhexidine.

Suitable oxidizing agents for use in this disclosure include, but are not limited to, persalt agents such as perborates, percarbonates and perpyrophosphonates; and the alkali metal and alkaline earth metal peroxides, or a combination thereof. Examples of suitable agents include potassium, ammonium, sodium and lithium perborate mono- and tetrahydrates; sodium pyrophosphate peroxyhydrate; and magnesium, calcium, strontium and zinc peroxides, or a combination thereof. Suitably, an organic acid peroxide, for example, succinic acid peroxide, oxalic acid, malonic acid, glutaric acid, adipic acid, pimelic acid, tannic acid, tartaric acid, citric acid, and combinations thereof, can be used as an oxidizing agent.

The oxidizing agent is contained in the formulation in an amount between 15 and 70 percent weight/weight (% w/w). In one embodiment, there is a combination of perborate and percarbonate oxidizing agents. In this embodiment, the perborate oxidizing agent is contained in the formulation in an amount between 5 and 15% w/w of the total composition and the percarbonate oxidizing agent is contained in the formulation in an amount between 5 and 15% w/w of the total composition. In another embodiment, there is also either perborate only or percarbonate only as the oxidizing agents. In this embodiment, the oxidizing agent is contained in the formulation in an amount between 20 and 30% w/w of the total composition. The oxidizing agents are generally available from DuPont located in Wilmington, Del., USA.

In addition to chlorhexidine and the oxidizing agent, the formulation may contain one or more excipients suitably found in known dental appliance cleansers, including, but not limited to surfactants, bleach activators (e.g., tetraacetylethylenediamine, chelating agents, enzymes, flavoring agents, lubricants for tablet processing (sodium benzoate, polyethylene glycol, magnesium stearate), antimicrobial compounds, sweeteners (saccharin, xylitol, sucralose), tablet binders and fillers (polyvinylpyrrolidone, cellulosics, starches), moisture scavengers, preservatives, and the like.

The formulation may contain one or more surfactants including, but not limited to, cationic surfactants, zwitterionic surfactants and non-ionic surfactants, or a combination thereof. The total concentration of surfactants contained in the formulation may be between 0.1 and 10% w/w of the total composition.

Suitable cationic surfactants include, but are not limited to, cetylpyridinium chloride, cetyltrimethyl ammonium bromide, diisobutyl phenoxy ethoxy ethyl dimethylbenzyl ammonium chloride and coconut alkyl trimethyl ammonium nitrate. Anionic surfactants are not favored in the inventive formulations as they may give rise to incompatibility with chlorhexidine.

One embodiment contains cetylpyridinium chloride, in an amount between 0.1 and 3% w/w of the total composition. Another embodiment contains cetylpyridinium chloride, in an amount between 4.0 and 7.0% w/w of the total composition.

Suitable non-ionic surfactants include, but are not limited to; polyoxyl hydrogenated castor oil, the ethoxylated sorbitan alkanoates, fatty acid ethoxylates, fatty alcohol ethoxylates, fatty amine ethoxylates, polyethylene oxide/polypropylene oxide block polymers (Pluronics) and sucrose esters.

Suitable zwitterionic surfactants include, but are not limited to, cocamidopropyl betaine and alkyl amidopropyl betaines.

Generally the surfactants disclosed herein are commercially available from Stepan Company, Northfield, Ill., USA.

The formulation may contain one or more chelating agents beneficial in aiding cleaning and bleach stability by keeping metal ions, such as calcium, sodium, and heavy metal cations, in solution. Chelating agents, include, but are not limited to, sodium polyphosphate, sodium tripolyphosphate, sodium acid pyrophosphate, tetrasodium pyrophosphate, aminopolycarboxylates such as nitrilotriacetic acid and ethylenediamine tetraacetic acid and salts thereof, and polyphosphonates and aminopolyphosphonates such as ethylenediamine tetramethylenephosphonic acid, diethylenetiraminepenta-methylenephosphonic acid and salts thereof, and combinations thereof. When present, the chelating agent is contained in the formulation in an amount between land 20% w/w of the total composition. In one embodiment, the chelating agent is sodium polyphosphate available commercially from Innophos, Cranbury, N.J., USA, and is found in an amount between about 10 and 18% w/w of the total composition. In another embodiment, the chelating agent is sodium EDTA available from Dow Chemical Company, Midland, Mich., USA, and is found in an amount between 1 and 5% w/w of the total composition. In yet another embodiment, there is a combination of EDTA and sodium polyphosphate, for a total range of 1-20% w/w of the total composition.

Flavorants suitable for use in the compositions of the disclosure include, but are not limited to, wintergreen oil, peppermint oil, spearmint oil, lemon, oil, orange oil, anise oil, clove oil, cinnamon leaf oil, or combinations thereof. Flavorants are found in the composition in an amount between 0.0 and 2.5% w/w of the total composition.

Suitable antimicrobial agents for use in this disclosure include, but are not limited to, thymol, menthol, triclosan, phenol, eucalyptol, benzoic acid, 4-hexylresorcinol, methylparaben, propylparaben, salicylamides, sodium benzoate, and combinations thereof. One of skill will recognize that the listed antimicrobial agents may also serve as a preservative in the inventive formulation.

Suitable moisture scavengers for use in this disclosure include, but are not limited to, soda ash (sodium carbonate) available commercially from FMC Industrial Chemicals Group, Philadelphia, Pa., USA.

Suitably, the formulation may contain an effervescent system that can consist of one or more ingredients for the intended purpose of either releasing or generating a gas such as carbon dioxide, oxygen, or nitrogen. An example of a single ingredient effervescent system is the use of zeolite that has been preloaded with carbon dioxide, which is released upon exposure to water. Examples of multiple ingredient effervescent systems include the combination of alkali metal carbonates, alkali metal hydrogen carbonates, organic carbonates (lysine carbonate, arginine carbonate) or alkali metal persulfates with carboxylic acids (citric acid, acid anhydrides); alkali metal carbonates, alkali metal hydrogen carbonates, organic carbonates or alkali metal persulfates with acid salts (hydrochloric acid, nitric acid); suitable combinations of the aforementioned compounds; and other known carbon dioxide and/or oxygen liberating reactions common to compositions in this art.

The compositions according to the present disclosure may be prepared by blending the ingredients, then packaging in a sachet or tabletting in accordance with art recognized procedures.

The dental appliance cleanser formulation can be in the form of a powder, sachet, tablet, gels, emulsions suspensions or liquids. Each dosage form may be packaged in a manner conventional in the art. As solid dosage forms, the dental appliance cleansing formulation is placed in water, or other suitable liquid, to form a cleansing composition and to activate the cleansing process.

Dental appliance cleansing formulations falling within the scope of this disclosure are more particularly illustrated in conjunction with the following non-limiting examples.

### EXAMPLES

### Example 1

The plaque preventative benefit resulting from the inclusion of chlorhexidine in a denture cleansing formulation was assessed using an in-vitro model. In place of a denture, 3″×1″ slides of acrylic (PMMA) resin were used as substrates. Prior to use, the slides were shot-blasted in order to roughen the surface, cleaned in detergent to remove dirt and grit, and dipped in methanol to provide further cleaning and to sterilize the surface.

Denture cleansing solutions were prepared using a commercially available effervescent tablet (Polident® Antibacterial, Dungarvan, Ireland). In accordance with manufacturer's directions, 1 tablet was added to 150 mL of 45° C. tap water to prepare a standard solution. To prepare the experimental solutions, a small quantity of chlorhexidine (1.375-5.500 mg, equivalent to 0.05%-0.20% w/w of the tablet respectively) was added to the standard solution and allowed to dissolve with slight agitation. Slides were immersed in the cleansing solutions for 5 minutes before being removed. Removal of residual cleansing solution was accomplished by dipping the slides in a beaker of water prior to setting the slides aside to dry.

To grow plaque on the slides, a broth was prepared consisting of 30 grams of Todd Hewitt Broth (dehydrated) and 10 grams of saccharose per liter of deionized water. The broth was sterilized in an autoclave for 15 minutes at 121° C. and 15 psi. After cooling to 40° C., the broth was inoculated with 5 mL of human saliva (that had been collected from the experimental operator) per liter of broth. After dispersing the saliva throughout the broth, the solution was poured over the top of the slides which had been placed in an autoclavable plastic tray. The tray was covered with a lid and incubated in an oven for 18 hours at 37° C.

After incubation, the slides were removed from the trays and allowed to air dry. Gentle rinsing by dipping in a beaker of water removed residual traces of broth. Final air drying was achieved by putting the slides in an oven at 37° C. for 45 minutes. The extent of plaque development was assessed by visual inspection and reflectometry following disclosure with red dye. The results of a typical experiment are reported below. As can be seen, the inclusion of trace quantities of chlorhexidine greatly enhances the resistance of the surface to subsequent biofouling.

| | % Plaque | |
|---|---|---|
| | Reduction | Appearance |
| Treatment | (Reflectometer) | (Visual Inspection) |
| Untreated slides | 0 | No reduction |
| Polident Antibacterial Formulation | 27.79 ± 15.78 | Moderate reduction |
| Polident Antibacterial Formulation + | 63.87 ± 5.54 | Strong reduction |
| 0.05% CHX | | |
| Polident Antibacterial Formulation + | 70.29 ± 5.02 | Strong reduction |
| 0.20% CHX | | |

The potential for chlorhexidine-induced staining was examined on specimens of Lucitone 199 denture acrylic (Dentsply, York, Pa.). In one study, the specimens were repeatedly treated using one of four exposure cycles:

1) Immersion in Polident Antibacterial (“Poli NB”)

2) Immersion in Polident Antibacterial with the addition of 0.05% CHX (“Poli NB +CHX)

3) Immersion in Polident Antibacterial with the addition of 0.05% CHX followed by immersion in strong tea (“Clean/Tea”)

4) Immersion in strong tea followed by immersion in Polident Antibacterial with the addition of 0.05% CHX (“Tea/Clean”)

After 30 days exposure to the various cycles, specimens were analyzed with a HunterLab MiniScan (HunterLab, Reston, Va.) colorimeter to detect the formation of stain.

| | L* | a* | b* |
|---|---|---|---|
| As Received | 41.54 ± 0.88 | 7.32 ± 0.84 | −1.36 ± 0.66 |
| Poli A/B | 41.09 ± 1.16 | 7.63 ± 0.54 | −1.44 ± 0.48 |
| Poli A/B + CHX | 40.92 ± 1.17 | 7.59 ± 0.32 | −1.15 ± 0.41 |
| Clean/Tea | 40.96 ± 0.72 | 7.74 ± 0.65 | −1.05 ± 0.48 |
| Tea/Clean | 40.87 ± 1.41 | 7.75 ± 0.70 | −1.13 ± 0.56 |

No statistically significant differences in color were attributable to any of the treatments.

### Example 2

The synergistic activity of the cleanser formulation was assessed using an in vitro suspension test representing in-use conditions. In-use conditions represent the actual consumer use of the cleanser (e.g., dissolved tablet concentrations, temperature, and contact time) versus Candida albicans as a relevant oral organism for the denture wearer.

To 150 mL of 40° C. water at time zero, the denture cleanser was added, followed by 2 mL of a 10⁸ cfu/mL test suspension. After 5 minutes, an aliquot of the solution was removed, neutralized and plated in order to evaluate the amount or log reduction of the test organism.

| Test Formulation | 1 | 2 | 3 | 4 |
|---|---|---|---|---|
| Ingredients (% w/w) based | % | % | % | 0.0018 g of |
| on 2.75 g tablet | | | | Chlorhexidine |
| | | | | alone |
| Sodium | 48.70 | 50.20 | 50.20 | |
| Bicarbonate/Plasdone S- | | | | |
| 630 VP/VA copolymer | | | | |
| Citric Acid | 20.00 | 20.00 | 20.00 | |
| Sodium Carbonate, | 10.00 | 10.00 | 10.00 | |
| anhydrous | | | | |
| Sodium Perborate, | 11.00 | 11.00 | 11.00 | |
| monohydrate | | | | |
| Sodium Benzoate | 3.00 | 3.00 | 3.00 | |
| Peppermint Oil | 0.80 | 0.80 | 0.80 | |
| Everlase | 0.50 | 0.50 | 0.50 | |
| PEG 8000 | 3.00 | 3.00 | 3.00 | |
| TAED | 3.00 | 3.00 | 3.00 | |
| [symbol] Chlorhexidine | | 0.1 | 0.2 | |

The 0.1% tablet concentration of chlorhexidine is equivalent to 2.75 mg in 150 mL of the cleaning solution or 0.0018% (w/v). The 0.2% tablet concentration of chlorhexidine is equivalent to 2.75 mg in 150 mL of the cleaning solution or 0.0037% (w/v).

| Log | | | | |
|---|---|---|---|---|
| Reduction @ | Test Formulation | | | |
| 5 min | 1 | 2 | 3 | 4 |
| Assay 1 | 1.05 | >3.28 | >3.28 | 0.00 |
| Assay 2 | 0.85 | >4.70 | >4.70 | — |
| Assay 3 | 0.72 | >4.58 | >4.58 | — |

These results demonstrate that the presence of very low levels of chlorhexidine in a persulfate-free cleanser formulation significantly increases the antimicrobial activity of the cleanser formulation, while the chlorhexidine treatment alone unexpectedly does not demonstrate any antimicrobial activity. A synergistic effect of the combination of a low concentration of chlorhexidine with a persulfate-free denture cleanser is demonstrated by this data.

### Example 3

The following tables list the ingredients for suitable formulations falling within the scope of this disclosure. A 2.75 gram tablet is used as a reference.

| | Concentration |
|---|---|
| Ingredients | (% w/w) |
| Sodium Bicarbonate/Plasdone S-630 | 47.1 |
| VP/VA Copolymer | |
| Citric Acid, Anhydrous | 20.00 |
| Sodium Carbonate, Anhydrous | 10.00 |
| Sodium Perborate, Monohydrate | 11.00 |
| Cetylpyridinium Chloride | 1.50 |
| Sodium Benzoate | 3.00 |
| Peppermint Oil | 0.80 |
| Proteolytic Enzyme | 0.50 |
| Polyethylene Glycol 8000 | 3.00 |
| Tetraacetylethylenediamine | 3.00 |
| CHLORHEXIDINE | 0.1 |
| TOTAL | 100.00 |

| | Concentration |
|---|---|
| Ingredients | (% w/w) |
| Sodium Bicarbonate/Plasdone S-630 | 44.04 |
| VP/VA Copolymer | |
| Citric Acid, Anhydrous | 20.00 |
| Sodium Carbonate, Anhydrous | 11.00 |
| Mint Flavor Mix | 1.10 |
| Sodium percarbonate | 10.00 |
| Sodium Polyphosphate | 5.86 |
| Sodium Benzoate | 2.50 |
| Polyethylene Glycol 8000 | 2.50 |
| Cetylpyridinium Chloride | 2.0 |
| Sodium Stearate | 0.50 |
| CHLORHEXIDINE | 0.5 |
| TOTAL | 100.00 |

The above description fully discloses the invention including preferred embodiments thereof. Modifications and improvements of the embodiments specifically disclosed herein are within the scope of the following claims. Without further elaboration it is believed that one skilled in the art can, given the preceding description, utilize the present invention to its fullest extent. Therefore any examples are to be construed as merely illustrative and not a limitation on the scope of the present invention in any way. The embodiments of the disclosure in which an exclusive property or privilege is claimed are defined as follows.

1. A persulfate-free dental appliance cleansing composition comprising a low concentration of chlorhexidine, or a pharmaceutically acceptable salt thereof, in a pharmaceutically acceptable carrier.

2. A persulfate-free dental appliance cleansing composition comprising a low concentration of chlorhexidine, or a pharmaceutically acceptable salt thereof, and a surfactant selected from a cationic surfactant, a non-ionic surfactant, a zwitterionic surfactant, or a combination thereof, in a pharmaceutically acceptable carrier.

3. A persulfate-free dental appliance cleansing composition comprising a low concentration of chlorhexidine, or a pharmaceutically acceptable salt thereof, an oxidizing agent selected from a perborate salt and a percarbonate salt, and a surfactant selected from a cationic surfactant, a non-ionic surfactant, a zwitterionic surfactant, or a combination thereof, in a pharmaceutically acceptable carrier.

4. A method of cleansing a dental appliance outside the oral cavity comprising maintaining the dental appliance in contact with a persulfate-free dental appliance cleansing composition comprising a low concentration of chlorhexidine, or a pharmaceutically acceptable salt thereof, for a time sufficient to clean the dental appliance and rinsing the dental appliance with water.

5. A method of cleansing a dental appliance outside the oral cavity comprising maintaining the dental appliance in contact with a persulfate-free dental appliance cleansing composition comprising an effervescent system and a low concentration of chlorhexidine, or a pharmaceutically acceptable salt thereof, for a time sufficient to clean the dental appliance and rinsing the dental appliance with water.

6. A method of cleansing a dental appliance outside the oral cavity comprising maintaining the dental appliance in contact with a persulfate-free dental appliance cleansing composition comprising an effervescent system, a surfactant and a low concentration of chlorhexidine, or a pharmaceutically acceptable salt thereof, for a time sufficient to clean the dental appliance and rinsing the dental appliance with water.

7. A method for preventing the occurrence and/or reducing the incidence of dental plaque in the mouth of a dental appliance wearer by cleansing the dental appliance with a persulfate-free dental appliance cleansing formulation comprising an effervescent system, a surfactant and a low concentration of chlorhexidine, or a pharmaceutically acceptable salt thereof, for a time sufficient to clean the dental appliance and rinsing the dental appliance with water, and placing the dental appliance in the mouth of the wearer.
